(19) United States
(12) Patent Application Publication
(10) Pub. No.: US 2025/0332950 A1
(43) Pub. Date: Oct. 30, 2025

(54) CONTROL SYSTEM FOR ELECTRIC VEHICLE

(71) Applicant: ISUZU MOTORS LIMITED, Yokohama-shi (JP)

(72) Inventor: Yuki TEMMA, Fujisawa-shi (JP)

(21) Appl. No.: 19/057,367

(22) Filed: Feb. 19, 2025

(30) Foreign Application Priority Data
Apr. 30, 2024 (JP) 2024-073943

(51) Int. Cl. B60L 53/80; B60K 35/10

(52) U.S. Cl. CPC B60L 53/80; B60K 35/10; B60L 2240/54

(57) ABSTRACT

Control system Cu for electric vehicle C includes: first key cylinder 101 that generates an activation command by a key-on operation by a user; and second key cylinder 102 that generates a replacement command for starting a replacement procedure of the battery by a key-on operation by the user, in which a common key is used for key K for first key cylinder 101 and key K for second key cylinder 102.

### TECHNICAL FIELD

The present disclosure relates to a control system for an electric vehicle.

### BACKGROUND ART

Conventionally, electric vehicles (for example, electric automobiles and electric scooters) equipped with batteries are known.

In recent years, there has been an increasing number of cases where an electric vehicle of this type is equipped with a battery replacement system. Such a battery replacement system is generally designed based on the concept of replacing a battery, when the storage power of the battery mounted on the vehicle has decreased, with another battery that has been fully charged at a battery replacement station, instead of charging the battery each time (see, for example, Patent Literature (hereinafter referred to as “PTL” 1).

In this type of battery replacement system, the operation of a lock mechanism (for example, see FIGS. 3 and 4 to be described later) that supports and fixes a battery to a vehicle frame is controlled under the control of an electronic control unit (ECU), and the battery is removed from the vehicle frame and/or attached to the vehicle frame. At this time, the ECU establishes communication with a battery replacement station and, in cooperation with a battery replacement machine of the battery replacement station, causes the battery replacement machine to perform replacement of the battery mounted on the vehicle.

### CITATION LIST

### Patent Literature

PTL 1
Japanese Patent Application No. 2023-134543
PTL 2
Japanese Patent Application Laid Open No. 2000-225923

### SUMMARY OF INVENTION

### Technical Problem

Incidentally, this type of battery replacement system is currently under development, and has not yet reached the stage of identifying various problems that may arise during an actual use of a vehicle and optimizing the entire control system of the vehicle.

In such a background, the inventor of the present application has conceived a problem in that, in a situation where a vehicle is actually used, there is a possibility that a driver may perform a vehicle activation operation (that is, an ignition switch ON operation in a key cylinder) during battery replacement. In such a case, upon receiving a vehicle activation command from the key cylinder, a system main relay in wiring that connects the battery and a drive motor of the vehicle is brought into an on state, and a high voltage generated at a terminal portion of the battery is applied to a battery connector on a vehicle side in a non-connected state, which may cause arc discharge. As a result, situations may occur the battery connector becomes welded or other components are damaged.

Note that the system main relay is disposed, for example, in an output portion on a battery side, and is designed to be brought into an on state in order to make the vehicle ready for traveling when a vehicle activation operation is performed.

Further, when the vehicle activation operation is performed during the battery replacement, the ECU will notify the battery replacement station of an emergency stop command for a battery replacement procedure to avoid danger. As a result, there is a risk of unnecessarily redoing the battery replacement procedure or inducing an operation failure in the battery replacement machine of the battery replacement station.

An object of the present disclosure, which has been conceived in view of these problems, is to provide a control system for an electric vehicle capable of preventing a situation in which a vehicle activation operation is performed during battery replacement.

Principally, the present invention that solves the aforementioned problem is a control system for an electric vehicle equipped with a battery, the control system including:
a first key cylinder that generates an activation command for activating the electric vehicle by a key-on operation by a user; and
a second key cylinder that generates a replacement command for starting a replacement procedure of the battery by a key-on operation by the user, in which
a common key is used for a key for the first key cylinder and a key for the second key cylinder.

### Advantageous Effects of Invention

According to a control system for an electric vehicle of the present invention, it is possible to prevent a situation in which a vehicle activation operation is performed during battery replacement.

### BRIEF DESCRIPTION OF DRAWINGS

FIG. 1 illustrates an exemplary configuration of a vehicle (plan view);

FIG. 2 illustrates an exemplary mode of attaching a main battery to the vehicle;

FIG. 3 illustrates an exemplary configuration of a lock mechanism for fixing the main battery to the vehicle (unlocked state);

FIG. 4 illustrates another exemplary configuration of the lock mechanism for fixing the main battery to the vehicle (locked state);

FIG. 5 illustrates an appearance of the main battery;

FIG. 6 illustrates an exemplary drive mechanism of the lock mechanism; and

FIG. 7 illustrates an exemplary configuration of a control system for the vehicle.

### DESCRIPTION OF EMBODIMENTS

A preferred embodiment of the present disclosure will be described in detail with reference to the attached drawings. Note that elements having substantially the same functions are assigned the same reference numerals in the description and drawings to omit duplicated descriptions thereof. Further, each drawings illustrates a common orthogonal coordinate system.

Hereinafter, exemplary configurations of an electric vehicle (hereinafter, referred to as “vehicle C”) and a control system for vehicle C (hereinafter, referred to as “control system Cu”) according to an embodiment of the present invention will be described.

In the present embodiment, a battery replacement function of control system Cu will be mainly described. Here, a battery to be replaced in control system Cu is, for example, mounted on an electric vehicle such as an electric automobile or a hybrid automobile and is used as a drive power source for the vehicle (hereinafter, also referred to as a “main battery”).

### <Overall Configuration of Vehicle>

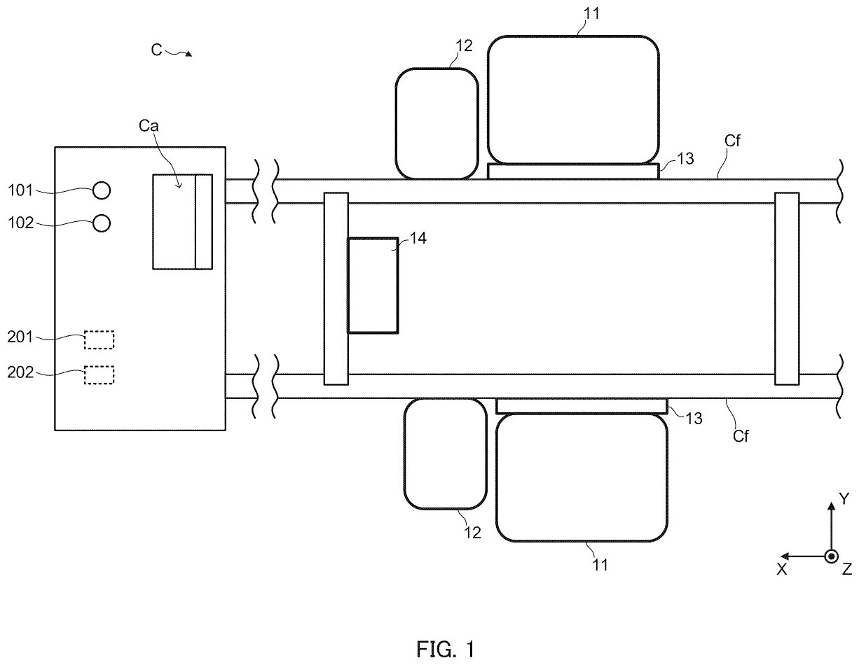

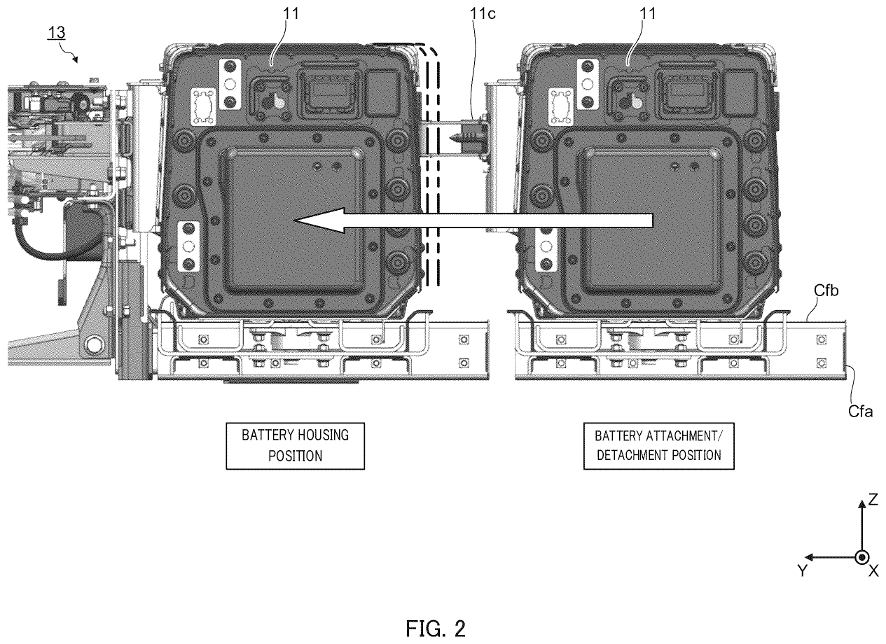

FIG. 1 illustrates an exemplary configuration of vehicle C (plan view). FIG. 2 illustrates an exemplary mode of attaching main battery 11 to vehicle C.

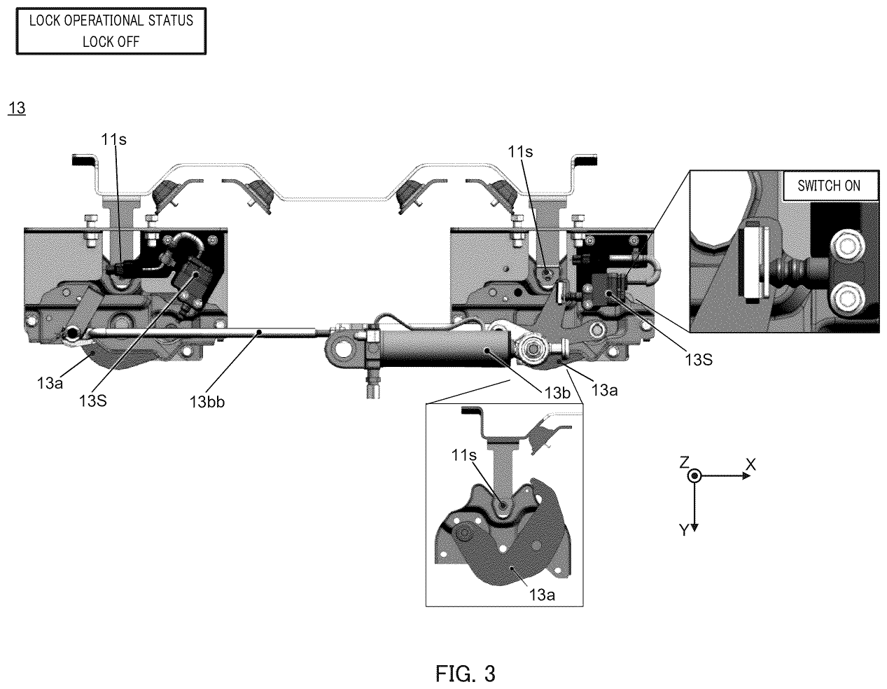

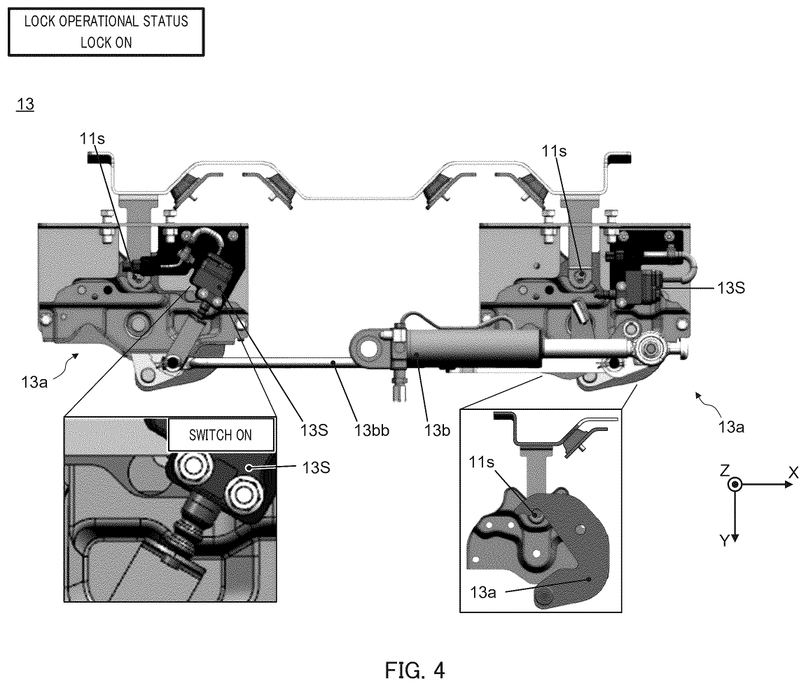

FIGS. 3 and 4 each illustrate an exemplary configuration of lock mechanism 13 that fixes main battery 11 to vehicle C (plan view). FIG. 3 illustrates an unlocked state of lock mechanism 13, and FIG. 4 illustrates a locked state of lock mechanism 13.

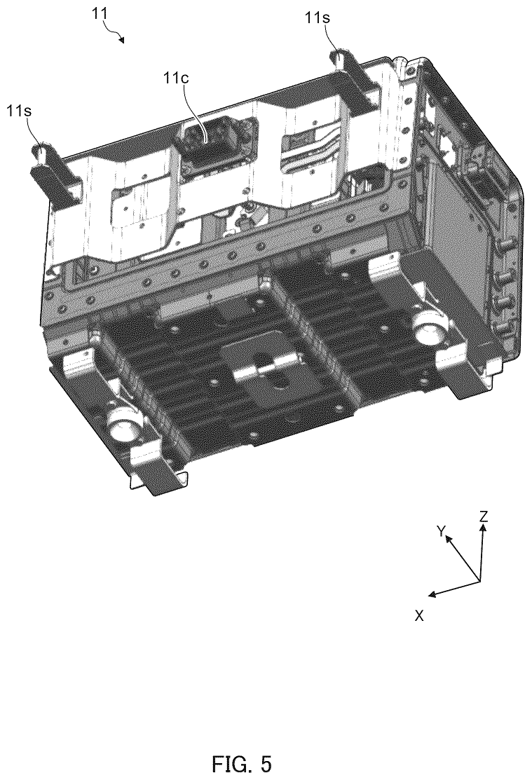

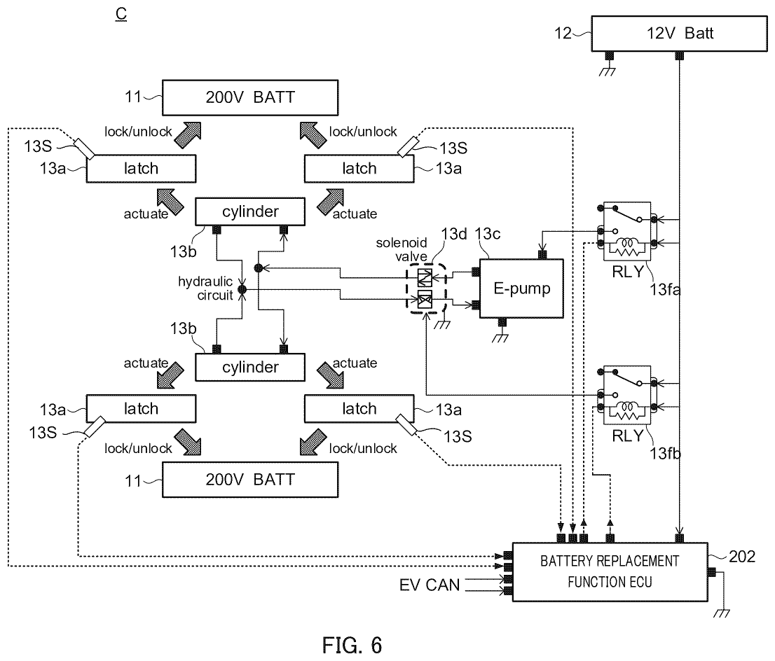

FIG. 5 illustrates an appearance of main battery 11. FIG. 6 illustrates an exemplary drive mechanism of lock mechanism 13.

Vehicle C is a vehicle, such as an electric automobile or a hybrid vehicle, which can travel using the drive power source of main battery 11. FIG. 1 illustrates, as an example, a configuration of a large-sized vehicle such as a truck. Note that vehicle frame Cf of vehicle C extends along a front-rear direction of the vehicle, is disposed on each side of left and right of the vehicle, and supports a vehicle body and various on-board devices. Further, vehicle frame Cf supports a cab that forms driver-seat Ca at a front portion of vehicle C. Vehicle frame Cf is formed of, for example, a steel bone material having a U-shaped cross section.

Vehicle C includes main battery 11, auxiliary battery 12, lock mechanism 13, drive motor 14, first key cylinder 101, second key cylinder 102, vehicle control function ECU 201, and battery replacement function ECU 202.

Main battery 11 is a high-voltage battery that supplies an operational power for driving vehicle C to drive motor 14. In the present embodiment, a battery pack of a 200 V class lithium-ion battery is used as main battery 11, for example.

Main battery 11 is detachably attached to a side-surface portion of vehicle frame Cf via lock mechanism 13. In the present embodiment, main battery 11 is attached to each of left-side vehicle frame Cf and right-side vehicle frame Cf.

Note that main battery 11 includes terminal portion 11c on a side surface, and is electrically connectable to a battery connector (not illustrated) on a vehicle C side via terminal portion 11c. Further, main battery 11 includes battery bracket 11a to which striker 11s that is rod-shaped for engaging with latch 13a of lock mechanism 13 is attached (see FIG. 5).

As illustrated in FIG. 2, vehicle frame Cf includes placing table Cfb on which main battery 11 is placed and slide rail base Cfa that slidably supports placing table Cfb. Slide rail base Cfa is attached to an outer-side surface of vehicle frame Cf and extends in a horizontal direction from vehicle frame Cf toward a laterally outside of vehicle C. Further, slide rail base Cfa guides placing table Cfb to be slidable between a battery housing position and a battery attachment/detachment position in vehicle C.

FIG. 2 illustrates a state in which placing table Cfb is slid to the battery housing position from a state in which placing table Cfb is drawn out to the battery attachment/detachment position.

In vehicle C according to the present embodiment, when main battery 11 is to be housed in vehicle C, main battery 11 is placed on placing table Cfb when placing table Cfb is in the battery attachment/detachment position. Main battery 11 is then slid on slide rail base Cfa under a state of being placed on placing table Cfb, and is guided from the battery attachment/detachment position to the battery housing position. Main battery 11 is thus locked to vehicle frame Cf at the battery housing position using lock mechanism 13. At this time, terminal portion 11c of main battery 11 is connected to the battery connector on the vehicle C side, thereby completing the housing of main battery 11 in vehicle C.

In vehicle C according to the present embodiment, when main battery 11 is to be removed from vehicle C, for example, lock mechanism 13 is driven to release the locked state of main battery 11 to vehicle frame Cf. Main battery 11 is then slid by slide rail base Cfa under a state of being placed on placing table Cfb, and is guided from the battery housing position in vehicle C to the battery attachment/detachment position. Main battery 11 is thus, for example, lifted by a battery replacement machine of a battery replacement station at the battery attachment/detachment position and is removed from vehicle C.

Note that, for an example of the operation of the battery replacement machine of the battery replacement station, reference to, for example, PTL 1 of the related application by the applicant of the present application is encouraged.

Auxiliary battery 12 is a low-voltage battery that supplies an operational power to the on-board electrical components. Auxiliary battery 12 is, for example, a 12V lead-acid battery. Auxiliary battery 12 is fixed to a side-surface portion of vehicle frame Cf. In vehicle C according to the present embodiment, for example, an ECU (for example, vehicle control function ECU 201 and battery replacement function ECU 202) and lock mechanism 13 operate with the power supplied from auxiliary battery 12 (see FIG. 6).

Lock mechanism 13 is fixed to vehicle frame Cf and attaches main battery 11 to vehicle frame Cf in a detachable manner (see FIGS. 3, 4, and 6). Note that, in FIGS. 3 and 4, main battery 11 is not illustrated, and only battery bracket 11a and striker 11s that are attached to a side surface of main battery 11 are illustrated.

Lock mechanism 13 according to the present embodiment is configured to include latch 13a, hydraulic cylinder 13b, drive pump 13c, control valve 13d, first relay 13fa, and second relay 13fb.

Latches 13a are provided in a pair along a front-rear direction of vehicle frame Cf. Each of the pair of latches 13a is rotatably supported around a vertical axis with respect to a bracket attached to vehicle frame Cf. Each of the pair of latches 13a is a hook member that extends from an inside to an outside of vehicle frame Cf and is caught by striker 11s that is rod-shaped. Then, each of the pair of latches 13a rotates around the vertical axis in conjunction with the operation of hydraulic cylinder 13b.

That is, when locking main battery 11 to vehicle frame Cf, each of the pair of latches 13a rotates to one side around the vertical axis, engages with striker 11s attached to battery bracket 11a, and thereby fixes main battery 11 to vehicle frame Cf. Meanwhile, when unlocking main battery 11 from vehicle frame Cf, each of the pair of latches 13a rotates to the other side around the vertical axis, releases the engaged state with striker 11s of battery bracket 11a, and makes main battery 11 detachable from vehicle frame Cf.

Lock mechanism 13 typically holds the locked state in which main battery 11 is fixed to vehicle frame Cf when main battery 11 is to be housed in vehicle C. Further, lock mechanism 13 releases the locked state between main battery 11 and vehicle frame Cf when main battery 11 is replaced.

Note that, in the present embodiment, one side of the pair of latches 13a is directly connected to hydraulic cylinder 13b, and the other side of the pair of latches 13a is connected to hydraulic cylinder 13b via rod 13bb. Further, each of the pair of latches 13a is provided with contact sensor 13S, which can detect whether the locked state is established. Sensor signals from contact sensors 13S are transmitted to battery replacement function ECU 202, and battery replacement function ECU 202 is configured to detect malfunctions or other issues in lock mechanism 13, based on these sensor signals.

Hydraulic cylinder 13b is connected to a hydraulic circuit, and changes in state depending on operation states of drive pump 13c, which supplies hydraulic oil to the hydraulic circuit, and control valve 13d, which is disposed in the hydraulic circuit. That is, drive pump 13c sends high-pressure hydraulic oil to the hydraulic circuit, and control valve 13d controls a supply state of the hydraulic oil to hydraulic cylinder 13b. Thus, hydraulic cylinder 13b converts fluid energy of the hydraulic oil into mechanical energy to move the pair of latches 13a.

The operation state of hydraulic cylinder 13b is controlled by battery replacement function ECU 202 that controls drive pump 13c and control valve 13d. To be more specific, battery replacement function ECU 202 controls the operation of drive pump 13c by performing on/off control of first relay 13fa disposed in a line connecting between drive pump 13c and auxiliary battery 12 that supplies an operational power to drive pump 13c. Similarly, battery replacement function ECU 202 controls the operation of control valve 13d by performing on/off control of second relay 13fb disposed in a line connecting between control valve 13d and auxiliary battery 12 that supplies an operational power to control valve 13d.

Battery replacement function ECU 202 operates lock mechanism 13 to switch between the locked state and the unlocked state of main battery 11 with respect to vehicle frame Cf. Further, battery replacement function ECU 202 is configured to be capable of communicating with the battery replacement station, and executes the replacement procedure of main battery 11 in cooperation with the battery replacement station.

### <Control System for Vehicle>

Next, control system Cu for vehicle C according to the present embodiment will be described.

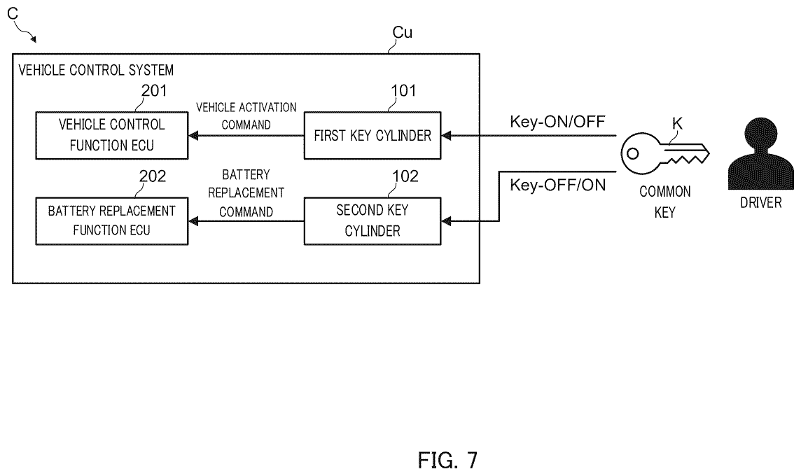

FIG. 7 illustrates an exemplary configuration of control system Cu for vehicle C.

As described above, vehicle C includes first key cylinder 101, second key cylinder 102, vehicle control function ECU 201, and battery replacement function ECU 202. Note that first key cylinder 101 and second key cylinder 102 are separately disposed, for example, on an instrument panel in front of driver seat Ca of vehicle C.

First key cylinder 101 is a key cylinder that functions as an ignition switch, and is configured integrally with the ignition switch of vehicle C. That is, first key cylinder 101 receives key K for vehicle C held by a driver, and when a key-on operation of rotating a rotor of first key cylinder 101 to a predetermined position is performed with key K, the built-in ignition switch is turned on. First key cylinder 101 transmits a vehicle activation command to vehicle control function ECU 201 when the ignition switch is brought into the on state.

Note that first key cylinder 101 is configured such that key K cannot be inserted or removed during a key-on state.

Vehicle control function ECU 201 is an ECU that performs integral control of each component of vehicle C. When receiving the vehicle activation command from first key cylinder 101, for example, vehicle control function ECU 201 brings a system main relay (not illustrated) in wiring connecting between battery 11 and drive motor 14 into an on state in order to make the vehicle ready for traveling.

Vehicle control function ECU 201 is, for example, a microcontroller configured to include a central processing unit (CPU), a read only memory (ROM), a random access memory (RAM), an input port, an output port, a communication module, and the like.

Second key cylinder 102 is a key cylinder that functions as a battery-replacement-command switch, and is configured integrally with the battery-replacement-command switch of vehicle C. That is, second key cylinder 102 receives key K for vehicle C held by the driver, and when a key-on operation of rotating a rotor of second key cylinder 102 to a predetermined position is performed with key K, the built-in battery-replacement-command switch is turned on. Second key cylinder 102 transmits a vehicle replacement command to battery replacement function ECU 202 when the battery-replacement-command switch is brought into the on state.

Note that second key cylinder 102 is configured such that key K cannot be inserted or removed during a key-on state.

As described above, battery replacement function ECU 202 is an ECU that controls the replacement procedure of battery 11. When receiving the battery replacement command from second key cylinder 102, for example, battery replacement function ECU 202 starts the replacement procedure of main battery 11 in cooperation with the battery replacement station.

Battery replacement function ECU 202 is, for example, a microcontroller configured to include a CPU, a ROM, a RAM, an input port, an output port, a communication module, and the like.

Note that the configurations of first key cylinder 101 and second key cylinder 102 are the same as that of a conventionally publicly-known key cylinder (see, for example, PTL 2).

Here, control system Cu for vehicle C according to the present embodiment is particularly characterized in that common key K is used for key K for first key cylinder 101 and key K for second key cylinder 102.

In control system Cu for vehicle C according to the present embodiment, such configuration is adopted to prevent the ignition switch and the battery-replacement-command switch from being turned on simultaneously. In other words, this is to prevent a situation in which the driver mistakenly attempts to execute the activation operation of vehicle C and the replacement procedure of battery 11 simultaneously.

That is, since the driver holds only one key K, when the driver inserts this key K into first key cylinder 101 and performs a key-on operation to activate vehicle C, second key cylinder 102 is always in a key-off state. Otherwise, when the driver inserts key K into second key cylinder 102 and performs a key-on operation to replace battery 11, first key cylinder 101 is always in the key-off state.

Thus, it is possible to prevent a situation in which a vehicle activation operation is performed during the battery replacement.

### [Effects]

As described above, control system Cu for electric vehicle C according to the present embodiment includes:
a first key cylinder that generates an activation command for activating the electric vehicle by a key-on operation by a user; and
a second key cylinder that generates a replacement command for starting a replacement procedure of the battery by a key-on operation by the user, in which
a common key is used for a key for the first key cylinder and a key for the second key cylinder.

Therefore, according to control system Cu for vehicle C of the present embodiment, it is possible to reliably prevent the vehicle activation operation from being performed during the battery replacement.

Thus, it is possible to prevent a situation in which arc discharge occurs due to the high voltage applied to terminal portion 11c of main battery 11, causing a battery connector or other components on the vehicle C side to be welded.

Further, it is possible to prevent a situation in which unnecessary redoing of the battery replacement procedure occurs and an operation failure in the battery replacement machine of the battery replacement station is induced.

The present invention is not limited to the above embodiment and can be applied to various modified modes.

For example, in the above embodiment, vehicle frame Cf including slide rail base Cfa has been described as an example of vehicle C to be applied to the present invention, but any support mode of main battery 11 is possible for achieving vehicle C according to the present invention.

Further, in the above embodiment, as an example of lock mechanism 13 to be applied to the present invention, a mode has been described in which main battery 11 is locked by a pair of latches 13a. However, lock mechanism 13 used in the present invention is optional, and other lock mechanisms may be used.

Further, in the above embodiment, a mode has been described in which vehicle control function ECU 201 that is activated by first key cylinder 101 and battery replacement function ECU 202 that is activated by second key cylinder 102 are configured as separate microcontrollers. However, in achieving control system Cu for vehicle C according to the present invention, the control section that is activated by first key cylinder 101 and the control section that is activated by second key cylinder 102 may be configured integrally. Further, these may be configured of a hardware circuit such as an Application Specific Integrated Circuit (ASIC) or a Field-Programmable Gate Array (FPGA) instead of a microcontroller.

The specific examples of the present disclosure have been described in detail above, but these specific examples are mere examples and do not limit the appended claims. The technology described in the appended claims embraces various modifications and changes made in accordance with the specific examples described above.

The disclosure of Japanese Patent Application No. 2024-73943, filed on Apr. 30, 2024 including the specification, drawings and abstract, are incorporated herein by reference in its entirety.

### INDUSTRIAL APPLICABILITY

According to a control system for an electric vehicle of the present invention, it is possible to prevent a situation in which a vehicle activation operation is performed during battery replacement.

### REFERENCE SIGNS LIST

C Vehicle
Cu Control System
11 Main battery
12 Auxiliary battery
13 Lock mechanism
14 Drive motor
101 First key cylinder
102 Second key cylinder
201 Vehicle control function ECU
202 Battery replacement function ECU

1. A control system for an electric vehicle equipped with a battery, the control system comprising:
a first key cylinder that generates an activation command for activating the electric vehicle by a key-on operation by a user; and
a second key cylinder that generates a replacement command for starting a replacement procedure of the battery by a key-on operation by the user, wherein
a common key is used for a key for the first key cylinder and a key for the second key cylinder.

2. The control system according to claim 1, wherein the first key cylinder and the second key cylinder are separately disposed on an instrument panel in front of a driver seat of the electric vehicle.
